(19) United States
(12) Patent Application Publication
(10) Pub. No.: US 2026/0121391 A1
(43) Pub. Date: Apr. 30, 2026

(54) Knock-Out for A/C Disconnect

(71) Applicant: Halex Electric Company, Harrison, OH (US)

(72) Inventors: Macario Santana GONZALEZ, Addyston, OH (US); Joshua Stephen SACKETT, Dayton, OH (US); David Vaughn McELVEEN, II, Fort Wayne, IN (US); Timothy Wayne BILLOW, Angola, IN (US)

(73) Assignee: Halex Electric Company, Harrison, OH (US)

(21) Appl. No.: 19/368,862

(22) Filed: Oct. 24, 2025

Related U.S. Application Data
(60) Provisional application No. 63/711,700, filed on Oct. 24, 2024.

(51) Int. Cl. H02G 3/08

(52) U.S. Cl. CPC H02G 3/085

(57) ABSTRACT

An enclosure for housing electrical components including a knock-out used to create a hole to allow wiring to pass through is described herein. The knock-out includes a set of two or more nested knock-out members each configured to create a hole having a different diameter, a plurality of engaging portions including an engaging portion for each of the knock-out members, and a plurality of reinforcing struts including a set of reinforcing struts for associated with each of the knock-out members. The engaging portions are configured to receive a tool used to knock out an associated knock-out member and prevent the tool from slipping when the tool is used to knock out the associated knock-out member. Each set of reinforcing struts is positioned around a periphery of an associated knock-out member and is configured to provide counterpoint reinforcement for an adjacent one of the set of knock-out members.

### RELATED APPLICATIONS

This application claims priority to U.S. Provisional Patent Application No. 63/711,700, filed Oct. 24, 2024, the content of which is incorporated herein by reference in its entirety.

### FIELD OF THE INVENTION

The present invention relates to electrical equipment and, more particularly, to a knock-out for use on an electrical box (such as, e.g., an A/C disconnect).

### BACKGROUND OF THE INVENTION

Electrical boxes and other types of enclosures are typically used to house a number of electrical components that may control the flow of electricity into or from a building, structure, or appliance. For example, such an enclosure may be used to house an air conditioning (A/C) disconnect switch, which is used to provide a mechanism to quickly shut off power to an A/C unit for maintenance or repairs. An enclosure used to house an A/C disconnect switch is referred to herein as an “A/C disconnect.” Enclosures used to house electrical components often include knock-outs, which may comprise pre-scored holes in electrical boxes or other types of enclosures that can be removed to allow wiring to pass through. Knock-outs are often located in different positions on an enclosure to accommodate wiring that enters and exits the enclosure from different directions.

Knock-outs also frequently include nested holes of varying diameters, such that the appropriately sized hole may be selected to meet the needs of a given installation. However, such knock-outs often suffer from various drawbacks. For example, a technician using a screw driver or other tool to “knock out” a particular hole may find it difficult to place the tool in a position associated with a hole of a desired diameter or may accidentally knock-out the wrong hole due to the tool in contact with the knock-out slipping prior to or during impact. Additionally, due to design flaws, an attempt to knock out a particular hole may result in the creation of a larger hole than was intended. This may require the expense of additional time and energy (and any resulting cost) to repair or replace the enclosure to ensure there are not holes that represent a potential hazard.

A knock-out that is easier to use and allows a desired hole to be more reliably knocked out would represent a significant improvement over conventional knock-out designs. For example, such a knock-out may the time, energy, and/or cost required to install or configure an electrical enclosure.

### SUMMARY OF THE INVENTION

Aspects of this disclosure relate to an enclosure for housing electrical components including a knock-out used to create a hole to allow wiring to pass through. For example, the enclosure may comprise an A/C disconnect. According to various aspects of this disclosure, the knock-out may comprise a set of two or more nested knock-out members, a plurality of engaging portions, and a plurality of reinforcing struts. In various embodiments, each of the knock-out members is configured to create a hole having a different diameter. An outer-edge of each of the knock-out members may be pre-scored to facilitate removal of the knock-out member from the enclosure. In various embodiments, the plurality of engaging portions may include at least one engaging portion associated with each of the knock-out members. The engaging portions are configured to receive a tool used to knock out an associated knock-out member. The engaging portions comprise divots in the surface of the associated knock-out member sized to receive the tool and prevent the tool from slipping when the tool is used to knock out the associated knock-out member. Each of the plurality of engaging portions may be offset from an engaging portion of the engaging portion associated with an adjacent one of the set of knock-out members. In some embodiments, each of the plurality of engaging portions may be offset from an engaging portion associated with an adjacent one of the set of knock-out members by substantially the same angle. In various embodiments, the plurality of reinforcing struts include a set of reinforcing struts associated with each of the knock-out members. Each set of reinforcing struts is positioned around a periphery of an associated knock-out member and is configured to provide counterpoint reinforcement for an adjacent one of the set of knock-out members. For example, the adjacent one of the set of knock-out members may comprise a knock-out member closest to but larger in diameter. The reinforcing struts may be provided at specific offset angles and/or positioned annularly around the knock-out. In various embodiments, each set of reinforcing struts comprises a pair of reinforcing struts.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a front view of an example knock-out having annular reinforcing struts and designated engaging (or impact) portions, according to one or more aspects described herein;

FIG. 2 depicts a perspective view of an example knock-out described herein positioned on an example enclosure, according to one or more aspects described herein;

FIGS. 3A-C depict various views of a component of an example enclosure that includes one or more knock-outs, according to one or more aspects described herein;

FIGS. 4A-B depict various views of an example knock-out having multiple knock-out members, according to one or more aspects described herein; and

FIG. 5 depicts a front view of a knock-out having example alternating angled struts, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

In the following description of various examples of the invention, reference is made to the accompanying drawings, which form a part hereof, and in which are shown by way of illustration various example structures, systems, and steps in which aspects of the invention may be practiced. These aspects are indicative, however, of but a few of the various ways in which the principles of the invention may be employed and the present invention is intended to include all such aspects and their equivalents. It is to be understood that other specific arrangements of parts, structures, example devices, systems, and steps may be utilized, and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three-dimensional orientation of structures in order to fall within the scope of this invention.

A knock-out providing greater ease of use and allowing desired holes to be more reliably “knocked out” and a method of using the same when installing an electrical enclosure (such as an A/C disconnect) is disclosed herein. In various embodiments, the knock-out may comprise reinforcing struts positioned around a periphery of individual knock-out members, each of which may be used to create a hole having a different diameter. The reinforcing struts may be included to provide counterpoint reinforcement for an adjacent knock-out member (i.e., the knock-out member closest to but larger in diameter). In some embodiments, the reinforcing struts may be provided at specific offset angles and/or positioned annularly around the knock-out. In some embodiments, each subsequent strut moving around the knock-out may be associated with one of the other knock-out members. In various embodiments, the knock-out may also include engaging (or impact) portions configured to receive a screwdriver (or other tool) used to knock out an associated knock-out member. The engaging (or impact) portions may prevent slipping or selection of the wrong hole when an enclosure including the knockout is being installed or configured.

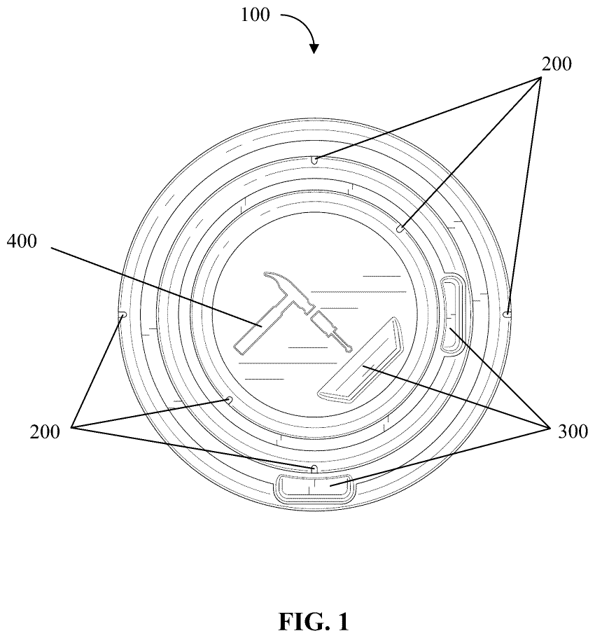

FIG. 1 depicts a perspective view of knock-out 100 having annular reinforcing struts and designated engaging (or impact) portions, according to one or more aspects described herein. In various embodiments, knock-out 100 may include annular reinforcing struts 200, one or more engaging (or impact) portions 300, a visual aid 400, and/or one or more other components. In various embodiments, and as described further herein, annual reinforcing struts 200 may be positioned at various locations on knock-out and provide counter point reinforcement to individual knock-out members, which are used to create holes of varying diameters. In various embodiments, engaging (or impact) portions 300 (which may also be referred to interchangeably herein as “engaging portions 300” and “impact portions 300”) may be configured to receive a screwdriver or other tool used to knockout specific holes and prevent slip or wrong hole selection, as described further herein. In various embodiments, visual aid 400 may comprise one or more of image(s), symbol(s), or text printed, engraved, or otherwise provided for display on a surface of knock-out 100. For example, as depicted in FIG. 1, visual aid 400 may provide a visual indication that a hammer and screwdriver (or interchangeable tools) should be used to knock out a desired hole in knock-out 100 (e.g., using engaging portions 300).

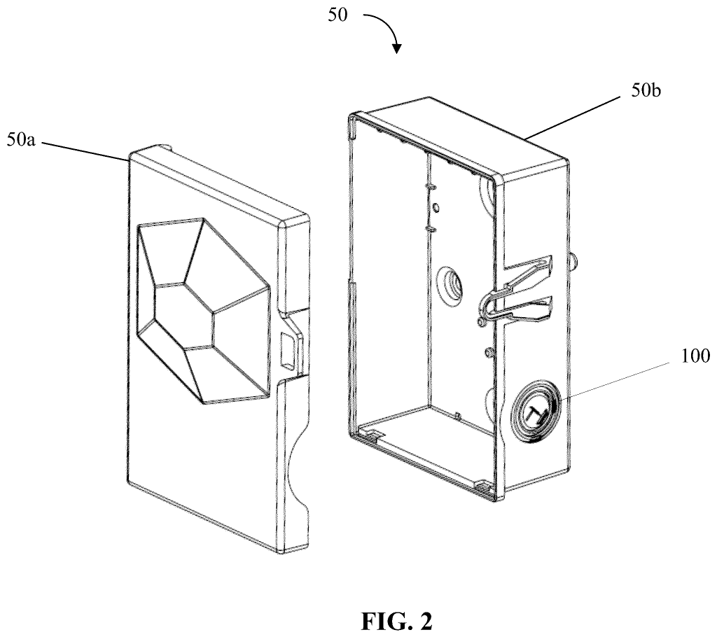

FIG. 2 depicts a perspective view of knock-out 100 a positioned on an enclosure 50, according to one or more aspects described herein. In various embodiments, an enclosure 50 including at least one knock-out 100 may be made up of a front portion 50a, a back portion 50b, and/or one or more other components. In various embodiments, knock-out 100 may be located or positioned on a side of one or more types of enclosures used to house electrical components (such as enclosure 50). For example, as depicted in FIG. 2, knock-out 100 may be located on a side of an enclosure 50 comprising an A/C disconnect.

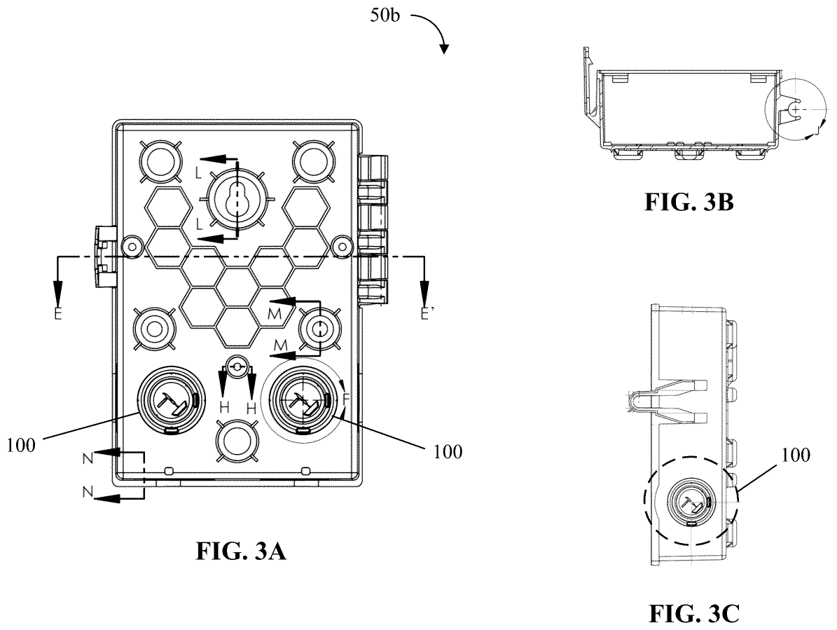

FIGS. 3A-C depict various views of a component of enclosure 50 that includes one or more knock-outs 100, according to one or more aspects described herein. For example, FIG. 3A depicts a back view of a back portion 50b of enclosure 50, FIG. 3B depicts a top view of back portion 50b of enclosure 50 as depicted in FIG. 3A along a line E-E′, and FIG. 3C depicts a side view of back portion 50b of enclosure 50. As depicted in FIG. 3A, back portion 50b may include two or more knock-outs 100 in a back of back portion 50b to be used to create holes for wiring or other electrical components to pass through the back of enclosure 50. As depicted in FIG. 3C, back portion 50b may include one or more knock-outs 100 in a side of back portion 50b to be used to create holes for wiring or other electrical components to pass through the side of enclosure 50. As will be appreciated a person having ordinary skill in the art, any number of knock-outs 100 may be included in a given disclosure without departing from the scope of the invention.

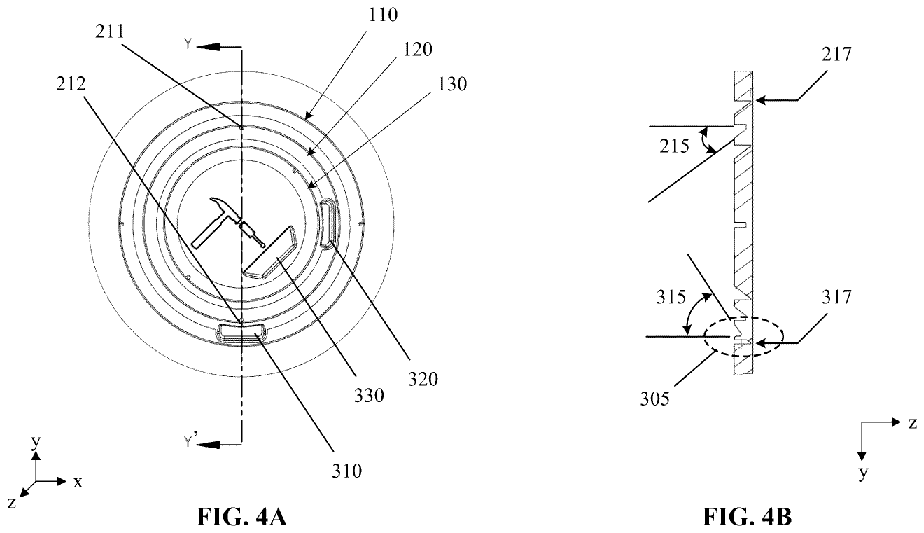

FIGS. 4A-B depict various views of an example knock-out 100 having multiple knock-out members, according to one or more aspects described herein. For example, FIG. 4A depicts a front view of an example knock-out 100, and FIG. 4B depicts a side cross-sectional view (i.e., in a y-z plane) of the knock-out 100 depicted in FIG. 4A along a line Y-Y′. As described herein, knock-out 100 may be used to create holes of varying diameters. Accordingly, in various embodiments, knock-out 100 may include multiple nested knock-out members (such as knock-out members 110, 120, and 130), each of which corresponding to the creation of a hole of a different diameter. Based on the size of the hole needed at the location of a particular knock-out 100 (e.g., due to the size of the one or more cables or other components that will pass through the hole), a technician may “knock out” the appropriate knock-out member (e.g., one of knock-out members 110, 120, and 130). As depicted in FIG. 4A, a diameter of a first knock-out member 110 may be larger than a diameter of a second knock-out member 120, and a diameter of a second knock-out member 120 may be larger than a diameter of a third knock-out member 130.

As described herein, knock-out 100 may include one or multiple annular reinforcing struts 200. In various embodiments, each reinforcing strut 200 may be located around a periphery of one or more knock-out members 110, 120, 130 to allow counter point reinforcement for one or more of the knock-out members 110, 120, 130. In some embodiments, each knock-out member 110, 120, 130 may have at least two reinforcing struts 200 for provide reinforcing force (or reinforcement) for that knock-out member. For example, as depicted in FIG. 4A, a first strut 211 and a second strut 212 may each be located along a periphery of second knock-out member 120 to provide reinforcing force (or reinforcement) for first knock-out member 110 when knocking out second knock-out member 120. In some embodiments, two reinforcing struts 200 (such as first strut 211 and second strut 212) may be provided on opposite sides of a circular knock-out members. In some embodiments, multiple reinforcing struts 200 may be spaced annularly around a periphery of circular knock-out members.

In various embodiments, annular reinforcing struts 200 may comprise angled reinforcing struts. For example, as depicted in FIG. 4B, annular reinforcing struts 200 may be provided at an angle 215. In an example embodiment, a first strut 211 and/or a second strut 212 of annular reinforcing struts 200 may be provided with an angle 45 degrees. However, in other embodiments, annular reinforcing struts 200 may be provided with an angle in a range between 0 and 90 degrees. In various embodiments, each of one or more knock-out members 110, 120, 130 may include a break point 217 to allow knock-outs to be quickly and easily removed (or knocked out) to accommodate one or multiple cables and/or provide access for a wide range of components. For example, in particular embodiments, a break point 217 may be provided with a thickness ratio of 10 percent full knock-out thickness. However, in various embodiments, break point thickness 217 may be provided in a range of 0 to 100 percent of a full knock-out thickness based on a material used for enclosure 50.

In various embodiments, knock-out 100 may include one or more engaging (impact) portions 300 integrated into a surface of knock-out 100 to facilitate engagement with a tool (such as the end of a screwdriver) with reduced risk of slip(s) or selection of the wrong hole to knock out when creating a hole for cables, pipes, and/or one or more other components in an enclosure (such as an A/C disconnect). In some embodiments, engaging portions 300 may essentially comprise screwdriver divots.

In various embodiments, each engaging portion 300 may comprise an inwardly concave groove located within the one of the knock-out members (such as one of knock-out members 110, 120, 130) that the engaging portion 300 is to be used to “knock out.” For example, as depicted in FIG. 4A, a first knock-out member 110 may include a first engaging (impact) portion 310 located within the first knock-out member 110 to prevent slip or unintentional selection of one of the other knock-out members (such as knock-out members 120 or 130) when knocking out first knock-out member 110. When looking at a cross section as depicted in FIG. 4B, each engaging (impact) portion 300 may be provided with an engaging (impact) profile 305. The engaging (impact) profile 305 may include an impact guiding angle 315 to guide impact toward an impact break point 317, such that the selected knock-out member (i.e., one of the one or more knock-out members 110, 120, 130) may be quickly and easily released from (or knocked out of) the enclosure.

In some embodiments, each engaging (impact) portion 300 may be located at a given angle relative to one or more reinforcing struts 200 intended to provide reinforcement for the next knock-out member (i.e., the knock-out member closest to but larger in diameter).

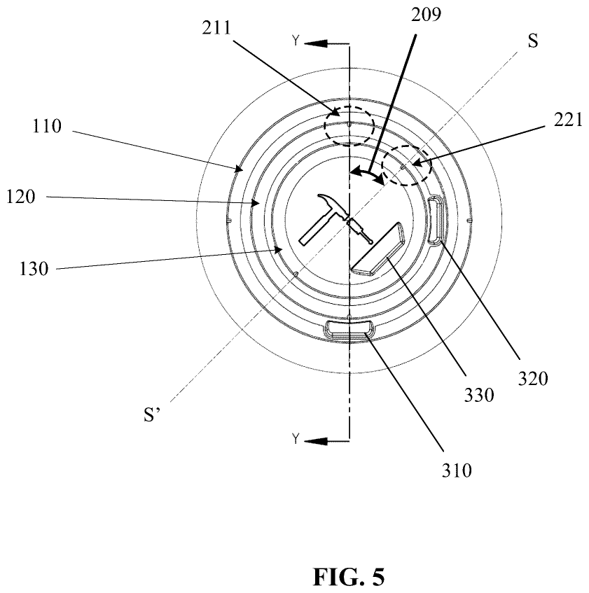

In various embodiments, reinforcing struts 200 of knock-out 100 may comprise alternating angled struts separated by an alternating offset angle 209. FIG. 5 depicts a front view of knock-out 100 having alternating angled struts 200, according to one or more aspects described herein. For example, as depicted in FIG. 5, alternating angled struts 202 may include a reinforcing strut 211 for reinforcing knock-out member 110 that is provided within knock-out 100 (i.e., along a line Y-Y′) at an alternating offset angle 209 with respect to reinforcing strut 221 for reinforcing knock-out member 120 (i.e., along a line S-S′). Here, the term “alternating” indicates that each subsequent strut, moving clockwise or counter-clockwise around knock-out 100 may be associated with another one of the knock-out members and equally spaced apart based on offset angle 209.

In some embodiments, knock-out 100 may similarly include engaging portions 300 that are positioned at a given angle with respect to one another and associated reinforcing struts 200. For example, a second engaging (impact) portion 320 may be located turning counterclockwise from third engaging (impact) portion 330 with respect to a center of the knock-out 100, and then first engaging (impact) portion 310 may be located turning clockwise from the second engaging (impact) portion 320 with respect to a center of the knock-out 100.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one embodiment”, “an embodiment”, “some embodiments”, “various embodiments”, “certain embodiments”, “other embodiments”, “one series of embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. An enclosure for housing electrical components including a knock-out used to create a hole to allow wiring to pass through, the knock-out comprising:
a set of two or more nested knock-out members, wherein each of the knock-out members is configured to create a hole having a different diameter;
a plurality of engaging portions including at least one engaging portion associated with each of the knock-out members, wherein the engaging portions are configured to receive a tool used to knock out an associated knock-out member; and
a plurality of reinforcing struts including a set of reinforcing struts associated with each of the knock-out members, wherein the set of reinforcing struts are positioned around a periphery of an associated knock-out member and configured to provide counterpoint reinforcement for an adjacent one of the set of knock-out members.

2. The enclosure of claim 1, wherein the engaging portions comprise divots in the surface of the associated knock-out member sized to receive the tool and prevent the tool from slipping when the tool is used to knock out the associated knock-out member.

3. The enclosure of claim 1, wherein the plurality of engaging portions includes one engaging portion for each of the knock-out members, and wherein each engaging portion is associated with only one knock-out member.

4. The enclosure of claim 1, wherein the adjacent one of the set of knock-out members comprises a knock-out member closest to but larger in diameter.

5. The enclosure of claim 1, wherein the reinforcing struts may be provided at specific offset angles and/or positioned annularly around the knock-out.

6. The enclosure of claim 1, wherein each set of reinforcing struts comprises a pair of reinforcing struts.

7. The enclosure of claim 1, wherein the knock-out further comprises a visual indication of a preferred tool to use when creating a hole using the knock-out.

8. The enclosure of claim 1, wherein an outer-edge of each of the knock-out members is pre-scored to facilitate removal of the knock-out member from the enclosure.

9. The enclosure of claim 1, wherein the knock-out is located on a side of the enclosure.

10. The enclosure of claim 1, wherein the enclosure includes multiple knock-outs each positioned on one or more of the sides, top, bottom, or back of the enclosure.

11. The enclosure of claim 1, wherein the set of two or more nested knock-out members includes a first knock-out member having a first diameter, a second knock-out member having a second diameter, and a third knock-out member having a third diameter,
wherein the second diameter of the second knock-out member is larger than the first diameter of the first knock-out member, and
wherein the third diameter of the third knock-out member is larger than the second diameter of the second knock-out member.

12. The enclosure of claim 11, wherein the plurality of engaging portions include a first engaging portion associated with the first knock-out member, a second engaging portion associated with the second knock-out member, and a third engaging portion associated with the third knock-out member.

13. The enclosure of claim 12, wherein the plurality of reinforcing struts include a first set of reinforcing struts associated with the first knock-out member, a second set of reinforcing struts associated with the second knock-out member, and a third set of reinforcing struts associated with the third knock-out member.

14. The enclosure of claim 13, wherein the first set of reinforcing struts includes a pair of reinforcing struts positioned a substantially equal distance from the first engaging portion, the second set of reinforcing struts includes a pair of reinforcing struts positioned a substantially equal distance from the second engaging portion, and the third set of reinforcing struts includes a pair of reinforcing struts positioned a substantially equal distance from the third engaging portion.

15. The enclosure of claim 1, wherein each of the plurality of engaging portions is offset from an engaging portion associated with an adjacent one of the set of knock-out members.

16. The enclosure of claim 15, wherein each of the plurality of engaging portions is offset from an engaging portion associated with an adjacent one of the set of knock-out members by substantially the same angle.
